(19) United States
(12) Patent Application Publication
(10) Pub. No.: US 2008/0265113 A1
(43) Pub. Date: Oct. 30, 2008

(54) DISPLAY DEVICE

(75) Inventors: Chung-Chi Lin, Taipei (TW); Jen-You Hou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/109,345

(22) Filed: Apr. 25, 2008

(30) Foreign Application Priority Data
Apr. 27, 2007 (TW) 96115034

(51) Int. Cl. F16M 11/18; G09G 3/28

(52) U.S. Cl. 248/176.3; 345/60

(57) ABSTRACT

A display device includes a display panel having a back cover, a body, a supporting plate and an adjusting mechanism. The adjusting mechanism includes a sliding rail support, a sliding block, a gear and a rotating member. The sliding rail support is fixedly connected to the back cover, and has a guiding structure disposed along the sliding rail support. The sliding block is slidably provided at the sliding rail support to move along thereof. The gear is connected to the sliding block. The gear and the guiding structure are clenched to position the sliding block at the sliding rail support. The rotating member has a first connecting portion and a second connecting portion. The first connecting portion is fixedly connected to the supporting plate, and the second connecting portion is pivotally connected to the sliding block, thereby adjusting the relative angle between the supporting plate and the sliding block.

### CROSS-REFERENCE TO RELATED APPLICATION

This application claims the priority benefit of Taiwan application serial no. 96115034, filed on Apr. 27, 2007. The entirety of the above-mentioned patent application is hereby incorporated by reference herein and made a part of this specification.

### BACKGROUND OF THE INVENTION

1. Field of the Invention

The invention relates to a display device and, more particularly, to a display device with an adjustable display panel.

2. Description of the Related Art

Along with the progress of the science and technology, computers become popular, and the time of using the computers becomes longer. Therefore, ergonomics designs of the computers and their peripheral devices are important to help users be able to use computers without health problems. Taking a display as an example, when a user views the display for a long time, eyes of the user easily become tired. The user may maintain an uncomfortable pose because of the height and angle of the display. Therefore, most of the conventional displays provide functions of adjusting the height and angle thereof to allow the users to comfortably operate the computers.

Laptop computers are gradually popular, and the user uses the laptop computer instead of the desktop computer to do work for long time. Therefore, the operational comfort of the laptop is gradually valued. Therefore, a conventional laptop is designed to have an adjustable display. For the kind of conventional laptop computer, the height of the display panel of the conventional laptop computer may be lifted, but the depression angle of the display panel cannot be adjusted.

To allow the user to have a comfortable environment to operate the computer, another conventional laptop computer with a display device whose height and depression angle can be adjusted is provided. Because of the structural interference, the user has to lift the display device to a highest position first, and then adjust the depression angle.

### BRIEF SUMMARY OF THE INVENTION

The invention provides a display device, and the height and depression angle of the display panel of the display device is freely adjustable by a user.

One embodiment of the invention provides a display device including a display panel, a body, a supporting plate and at least an adjusting mechanism. The display panel has a back cover. The supporting plate is pivotally connected to the body. The adjusting mechanism includes a sliding rail support, a sliding block, a gear and a rotating member. The sliding rail support is fixedly connected to the back cover, and it has a guiding structure disposed along the sliding rail support. The sliding block is slidably provided at the sliding rail support to move along the sliding rail support. The gear is connected to the sliding block. The gear and the guiding structure are clenched to allow the sliding block to be positioned at the sliding rail support. The rotating member has a first connecting portion and a second connecting portion. The first connecting portion is fixedly connected to the supporting plate, and the second connecting portion is pivotally connected to the sliding block, thereby adjusting the relative angle between the supporting plate and the sliding block.

In one embodiment of the invention, the display panel includes a liquid crystal display panel, a plasma display panel (PDP), an organic electro-luminescence display (OELD) panel or a field emission display (FED) panel.

In one embodiment of the invention, the body is the host of a laptop computer.

In one embodiment of the invention, the body is a base for supporting the display panel.

In one embodiment of the invention, two corresponding sides of the sliding rail support are limiting portions, the guiding structure is located between the limiting portions, and the limiting portions are suitable to limit the displacement distance of the sliding block.

In one embodiment of the invention, the guiding structure includes a plurality of positioning protrusions which are arranged at the same interval.

In one embodiment of the invention, the guiding structure is a rack.

In one embodiment of the invention, the guiding structure is a lead screw.

In one embodiment of the invention, the gear is a scroll wheel.

In one embodiment of the invention, the material of the guiding structure includes metal or plastic.

In one embodiment of the invention, the material of the gear includes metal or plastic.

In one embodiment of the invention, the adjusting mechanism further includes at least a sliding bar provided at the sliding rail support, and the sliding block moves along the sliding bar.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1A is a three-dimensional schematic diagram showing a display device of an embodiment of the invention.

FIG. 1B is a three-dimensional schematic diagram showing a lifting structure shown in FIG. 1A.

FIG. 2 is a three-dimensional schematic diagram showing the display device in FIG. 1A after the height of the display device is adjusted.

FIG. 3 is a three-dimensional schematic diagram showing the display device in FIG. 1A after the angle of the display device is adjusted.

### DETAILED DESCRIPTION OF THE EMBODIMENTS

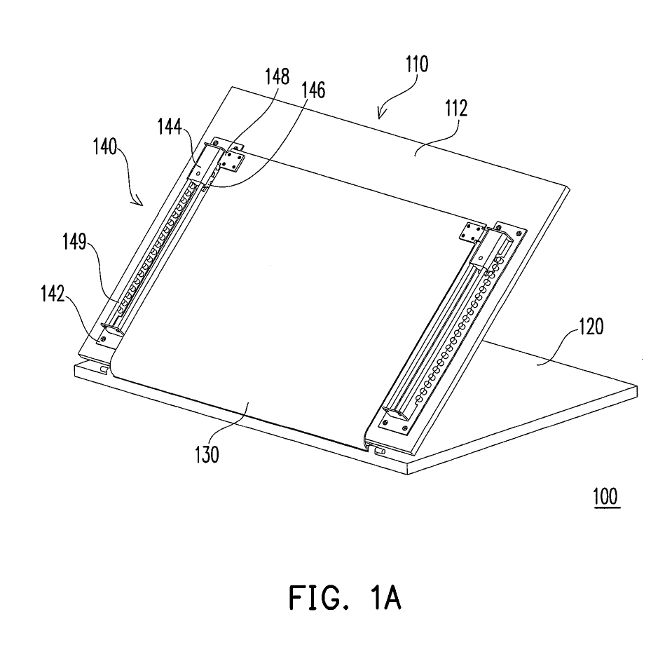

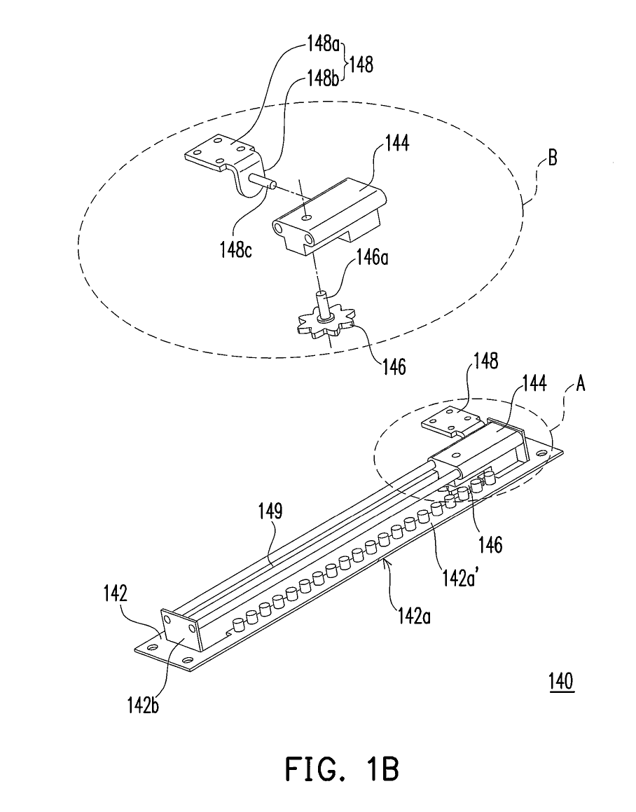

FIG. 1A is a three-dimensional schematic diagram showing a display device of an embodiment of the invention. As shown in FIG. 1A, a display device 100 includes a display panel 110, a body 120, a supporting plate 130 and at least an adjusting mechanism 140. The supporting plate 130 is pivotally connected to the body 120, and the adjusting mechanism 140 is fixedly connected to a back cover 112 of the display panel 110. The supporting plate 130 is connected to the display panel 110 by the adjusting mechanism 140.

In the embodiment, the body 120 of the display device 100 may be, for example, the host of a laptop computer, and it is electrically connected to the display panel 110. The host is used for processing electronic data and allows a processing result to be displayed on the display panel 110. In other embodiment of the invention, the body 120 may be a base for supporting the display panel 110. The display panel 110 may include a liquid crystal display panel, a plasma display panel (PDP), an organic electro-luminescence display (OELD) panel or a field emission display (FED) panel.

FIG. 1B is a three-dimensional schematic diagram showing a lifting structure shown in FIG. 1A. In FIG. 1B, the B area shows the pivotal connecting relationship of the sliding block, the rotating member and the gear in the A area. As shown in FIG. 1A and FIG. 1B, the adjusting mechanism 140 includes a sliding rail support 142, a sliding block 144, a gear 146 and a rotating member 148. The sliding rail support 142 is fixedly connected to the back cover 112, and it can be fastened to the back cover 112 by a plurality of fasteners (not shown). The sliding rail support 142 may be fixedly connected to the back cover 112 by close fitting or pasting, and so on.

The sliding rail support 142 has a guiding structure 142a, and the guiding structure 142a is disposed along the sliding rail support 142. The sliding block 144 is slidably provided at the sliding rail support 142 to move along the sliding rail support 142. In the embodiment, the guiding structure 142a includes a plurality of positioning protrusions 142a′ which are arranged at the same interval, and the material of the guiding structure 142a may be metal or plastic. In other embodiments of the invention, the guiding structure 142a may be a gear. Two corresponding sides of the sliding rail support 142 may be limiting portions 142b, and the guiding structure 142a is located between the limiting portions 142b. The limiting portions 142b are suitable to limit the displacement distance of the sliding block 144. The displacement distance is the lifting distance of the height that may be controlled by a user.

The gear 146 is connected to the sliding block 144. In the embodiment, the gear 146 may have a rotating shaft 146a, and the gear 146 is pivotally connected to the sliding block 144 by the rotating shaft 146a. The gear 146 and the guiding structure 142a are clenched to allow the sliding block 144 to be positioned at the sliding rail support 142. The gear 146 is suitable to drive the sliding block 144 by clenching between the gear 146 and the guiding structure 142a, and the material of the gear 146 may be metal or plastic.

The rotating member 148 is connected between the supporting plate 130 and the sliding block 144, and it has a first connecting portion 148a and a second connecting portion 148b. The first connecting portion 148a is fixedly connected to the supporting plate 130, and the second connecting portion 148b is pivotally connected to the sliding block 144. When the rotating member 148 rotates relatively to the sliding block 144, the supporting plate 130 and the sliding block 144 are driven to relatively rotate. In the embodiment, the rotating member 148 have a rotating shaft 148c, and it is pivotally connected to the sliding block 144 by the rotating shaft 148c.

The adjusting mechanism 140 may further include at least a sliding bar 149 provided at the sliding rail support 142, and two ends of the sliding bar 149 can be fixedly connected to the limiting portions 142b. The sliding bar 149 is provided through the sliding block 144 to enable the sliding block 144 to move along the sliding bar 149. To prevent the sliding block 144 from rotating around the sliding bar 149, two sliding bars 149 can be used to limit the sliding block 144, and then the sliding block 144 can only move and cannot rotate. The structural space limitation of the sliding rail support 142 and the sliding block 144 also can be used to limit the sliding block 144, and then the sliding block 144 can only move and cannot rotate. The number of the sliding bars 149 can be increased or decreased to cooperate with the size of the sliding block 144 or other consideration, and it is not limited in the invention. Friction force between the sliding bar 149 and the sliding block 144 can provide supporting force for the display panel 110 to prevent the display panel 110 from sliding down. In the embodiment, the above function is not limited to be obtained only by the mode of disposing the sliding bar 149.

As shown in FIG. 1A, when a user wants to open the display device 100, he can turn over the display panel 110 by the supporting plate 130 pivotally connected to the body 120, and the display panel 110 is close to the body 120 now.

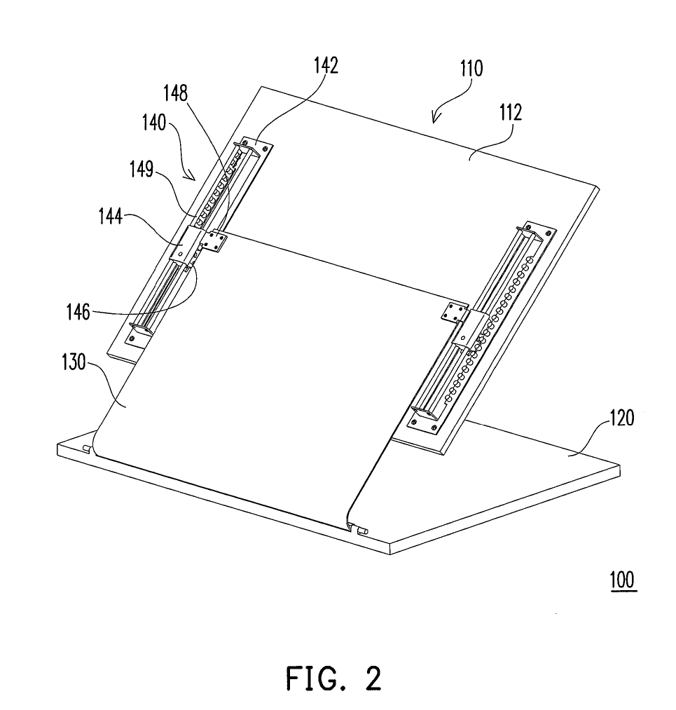

FIG. 2 is a three-dimensional schematic diagram showing the display device in FIG. 1A after the height of the display device is adjusted. As shown in FIG. 1B and FIG. 2, when the user feels that the inappropriate height of the display panel 110 causes the operation uncomfortable, the user can manually pull the display panel 110 upward to adjust the height of the display panel 110. At that moment, the gear 146 moves along the guiding structure 142a and drives the sliding block 144 to move at the same time. Since the rotating member 148 is fixedly connected to the supporting plate 130 and pivotally provided at the sliding block 144, the display panel 110 can move relatively to the supporting plate 130. At that moment, the display panel 110 is far away from the body 120.

By the adjusting mechanism 140 of the embodiment, the user can make the display panel 110 stop at a needed height, and he does not need to utilize additional holding, embedding or other positioning devices to maintain the height of the display panel 110. The display panel 110 cannot slide down because of gravity. The dentation structure of the gear 146 and the positioning protrusions 142a′ are embedded into each other structurally, and torque force at the pivotal connecting place where the rotating shaft 146a of the gear 146 is pivotally connected to the sliding block 144 can be used to balance off the gravity of the displaying panel 110. Therefore, the height of the display panel 110 relative to the supporting plate 130 can be maintained without additional mechanism or elements.

In the embodiment, although the display device 100 utilizes the gear 146 and the positioning protrusions 142a′ to realize positioning and guiding functions, in other embodiments of the invention, the guiding structure 142a may be other appropriate structure such as a lead screw pivotally connected to the sliding rail support 142, and the gear 146 may be a scroll wheel. Then, the positioning and guiding functions can also be obtained by clenching between the threads of the lead screw and the scroll wheel.

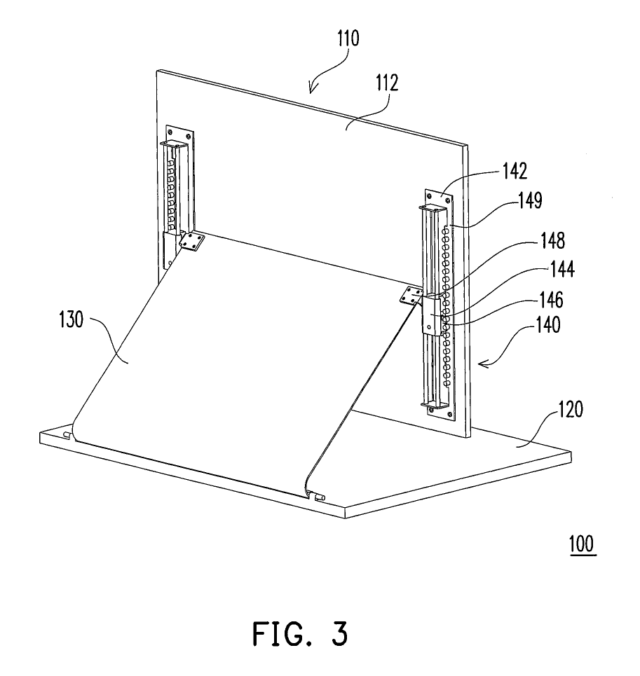

FIG. 3 is a three-dimensional schematic diagram showing the display device in FIG. 1A after the angle of the display device is adjusted. As shown in FIG. 1B and FIG. 3, when the display panel 110 arrives at a needed height, the depression angle of the display panel 110 can also affect the comfortable sense during operation. At that moment, the user can manually turn over the display panel 110 to adjust the depression angle of the display panel 110. In detail, the display panel 110 rotates relatively to the supporting plate 130 by the rotating member 148 pivotally connected to the sliding block 144 and fixedly connected to the supporting plate 130.

Similarly, after the display panel 110 rotates relatively to the supporting plate 130, by torque force at the pivotal connecting place where the rotating shaft 148c of the rotating member 148 is pivotally connected to the sliding block 144, the relative angle between the display panel 110 and the supporting plate 130 can be maintained without additional mechanism.

The display panel 110 of the display device 100 can be lifted relatively to the body 120 to an appropriate height for a user by the adjusting mechanism 140, and then the user can adjust the depression angle of the display panel 110. The depression angle of the display panel of a conventional display device can be adjusted only after the display panel is pulled to a highest position. Compared with the conventional display device, the display device 100 of the invention allows the user to randomly select a stop position for the display panel 110 in the lifting path of the display panel 110. Therefore, the display device 100 of the invention can accord with usage customs and poses of different users, and then the users can further comfortably view display images.

To sum up, the embodiment of the invention has following benefits.

First, a user may freely adjust the depression angle of the display panel by the adjusting mechanism of the display device of the invention, the height of the display panel can be selected according to personal stature, usage conditions and requirements.

Second, in the invention, the gear and the rotating member are pivotally connected to the sliding block, respectively, to generate torque force to maintain the height or angle of the display panel, and therefore, additional fixing structures are not needed, which saves material cost. For users, the usage is further elastic.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display device comprising:
a display panel having a back cover;
a body;
a supporting plate pivotally connected to the body;
at least an adjusting mechanism comprising:
a sliding rail support fixedly connected to the back cover and having a guiding structure disposed along the sliding rail support;
a sliding block slidably provided at the sliding rail support to move along the sliding rail support;
a gear connected to the sliding block, wherein the gear and the guiding structure are clenched to allow the sliding block to be positioned at the sliding rail support; and
a rotating member having a first connecting portion and a second connecting portion, wherein the first connecting portion is fixedly connected to the supporting plate, and the second connecting portion is pivotally connected to the sliding block to adjust the relative angle between the supporting plate and the sliding block.

2. The display device according to claim 1, wherein the display plane comprises a liquid crystal display panel, a plasma display panel (PDP), an organic electro-luminescence display (OELD) panel or a field emission display (FED) panel.

3. The display device according to claim 1, wherein the body is the host of a laptop computer.

4. The display device according to claim 1, wherein the body is a base for supporting the display panel.

5. The display device according to claim 1, wherein two corresponding sides of the sliding rail support are limiting portions, the guiding structure is located between the limiting portions, and the limiting portions are suitable to limit the displacement distance of the sliding block.

6. The display device according to claim 1, wherein the guiding structure comprises a plurality of positioning protrusions which are arranged at the same interval.

7. The display device according to claim 1, wherein the guiding structure is a rack.

8. The display device according to claim 1, wherein the guiding structure is a lead screw.

9. The display device according to claim 8, wherein the gear is a scroll wheel.

10. The display device according to claim 1, wherein the material of the guiding structure comprises metal.

11. The display device according to claim 1, wherein the material of the guiding structure comprises plastic.

12. The display device according to claim 1, wherein the material of the gear comprises metal.

13. The display device according to claim 1, wherein the material of the gear comprises plastic.

14. The display device according to claim 1, wherein the adjusting mechanism further comprises at least a sliding bar provided at the sliding rail support, and the sliding block moves along the sliding bar.
